(19) United States
(12) Patent Application Publication
(10) Pub. No.: US 2025/0282008 A1
(43) Pub. Date: Sep. 11, 2025

(54) EXTENDED BOLT RETHREADING TOOL AND A RETHREADING KIT AND METHOD OF RETHREADING A THREADED BOLT

(71) Applicant: Joseph Edwards, Buchtel, OH (US)

(72) Inventor: Joseph Edwards, Buchtel, OH (US)

(21) Appl. No.: 18/598,623

(22) Filed: Mar. 7, 2024

(51) Int. Cl. B23P 6/00

(52) U.S. Cl. CPC B23P 6/00

(57) ABSTRACT

An extended bolt rethreading tool includes a tool body having a connecting portion and a rethreading portion. The tool body is elongated and cylindrical. The connecting portion includes a connecting receptacle designed to receive and detachably connect to a drive head of a power drill, impact driver, ratchet, or similar tool to permit rotation of the tool body in a rethreading procedure. The rethreading portion includes a rethreading receptacle having female threading positioned on an interior surface of the rethreading receptacle. The rethreading receptacle is designed to receive and engage a threaded bolt or similar structure therein to permit a user to rethread a threaded bolt or similar structure using a power drill, impact driver, ratchet, or similar tool.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to rethreading devices and more particularly pertains to a new extended bolt rethreading tool for rethreading the threaded portions of threaded bolts or similar structures. Threaded bolts can often become damaged such that a threaded nut cannot be screwed onto the threaded bolt. Usually, it is easiest to simply replace the damaged threaded bolt with a new one. However, sometimes the threaded bolt is of an unusual size and/or is particularly or specially designed for a particular use, such as in a vehicle such as a car or airplane. In other instances, the threaded bolt is seated in a fixed position in a relatively inaccessible area, such as a tight compartment or space in a machine or as part of a larger assembly that cannot be easily disassembled. In such circumstances, it may be more advantageous, and possibly even necessary, to rethread the threaded portion. Rethreading devices are commonly used, which devices are usually in the form of a rethreading nut that can be screwed onto the threaded portion using a wrench. The rethreading nut is advanced along the threaded portion until the damaged areas have been rethreaded. However, if the threaded bolt is difficult to access or in a small or tight space, then it is very difficult if not impossible to use such a rethreading nut. The user is therefore left with a situation in which the user either has to take apart the surrounding components or try to force a nut onto the damaged threaded portion, both of which are undesirable. It therefore would be advantageous to have a rethreading device that would allow a user to rethread threaded bolts in such scenarios. In addition, it would be beneficial to allow the user to use a power tool to make the rethreading easier.

### (2) Description of Related Art Including Information Disclosed Under 37 CFR 1.97 and 1.98

The prior art relates to rethreading devices. The prior art, as best understood, does not disclose a rethreading device that has an extended or elongated body to permit rethreading of threaded bolts in inaccessible areas and/or using a power tool.

### BRIEF SUMMARY OF THE INVENTION

An embodiment of the disclosure meets the needs presented above in an extended bolt rethreading tool includes a tool body having a connecting portion and a rethreading portion. The tool body is elongated and cylindrical. The tool body includes a first end face and a second end face positioned at opposite ends of the tool body. The connecting portion includes a connecting receptacle having a connecting orifice positioned in the first end face. The connecting receptacle is designed to receive a drive head of a power drill, impact driver, ratchet, or similar tool to detachably connect the tool body to a drive head of a power drill, impact driver, ratchet, or similar tool to permit rotation of the tool body in a rethreading procedure. The rethreading portion includes a rethreading receptacle having a rethreading orifice positioned in the second end face. The rethreading receptacle includes female threading positioned on an interior surface of the rethreading receptacle. The rethreading receptacle is designed to receive and engage a threaded bolt or similar structure therein to permit a user to rethread a threaded bolt or similar structure using a power drill, impact driver, ratchet, or similar tool.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear perspective view of an extended bolt rethreading tool according to an embodiment of the disclosure.

FIG. 2 is a front perspective view of an embodiment of the disclosure.

FIG. 3 is a side view of an embodiment of the disclosure.

FIG. 4 is a cross-sectional view of an embodiment of the disclosure.

FIG. 5 is an exploded side view of an embodiment of the disclosure in use.

FIG. 6 is a side view of an embodiment of the disclosure in use.

### DETAILED DESCRIPTION OF THE INVENTION

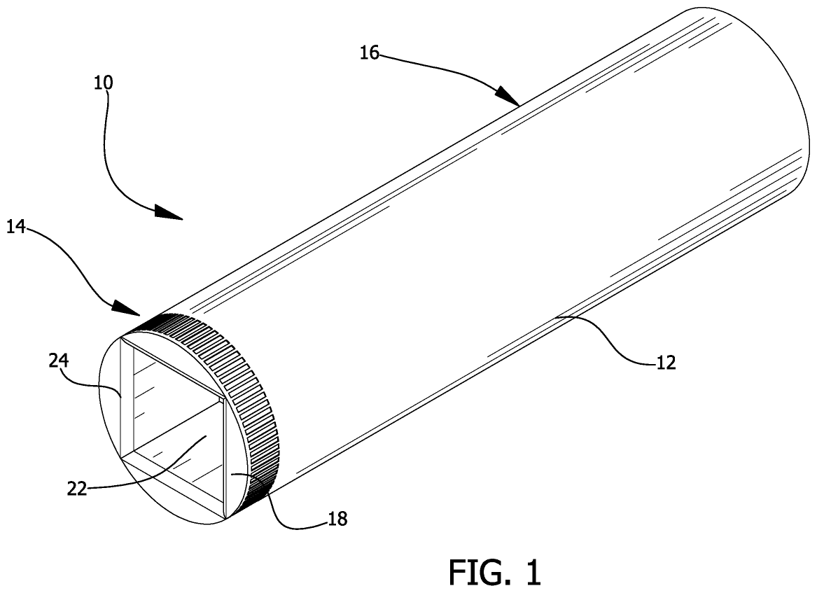

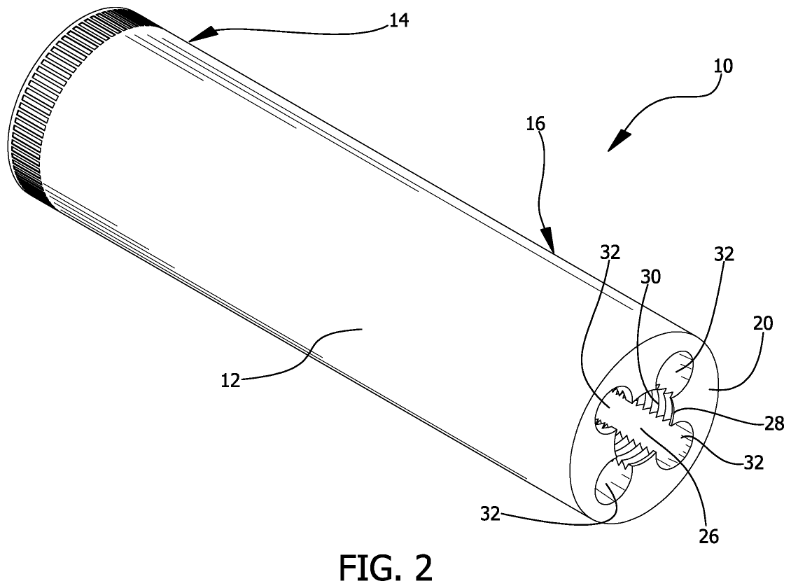

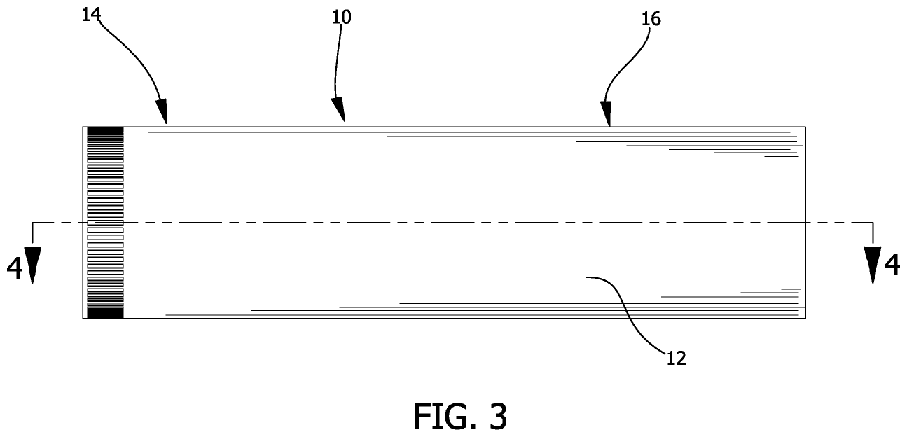

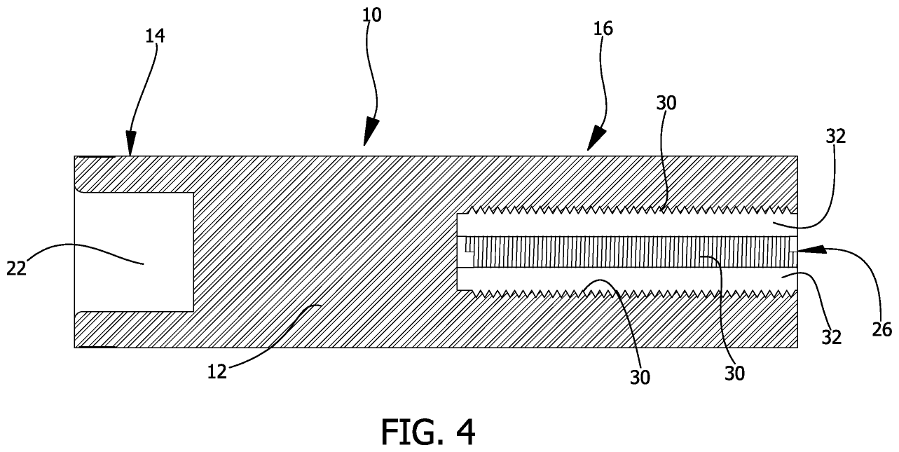

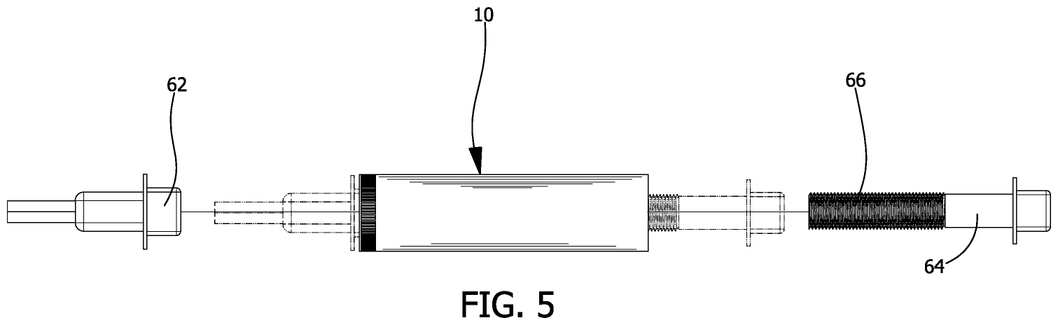

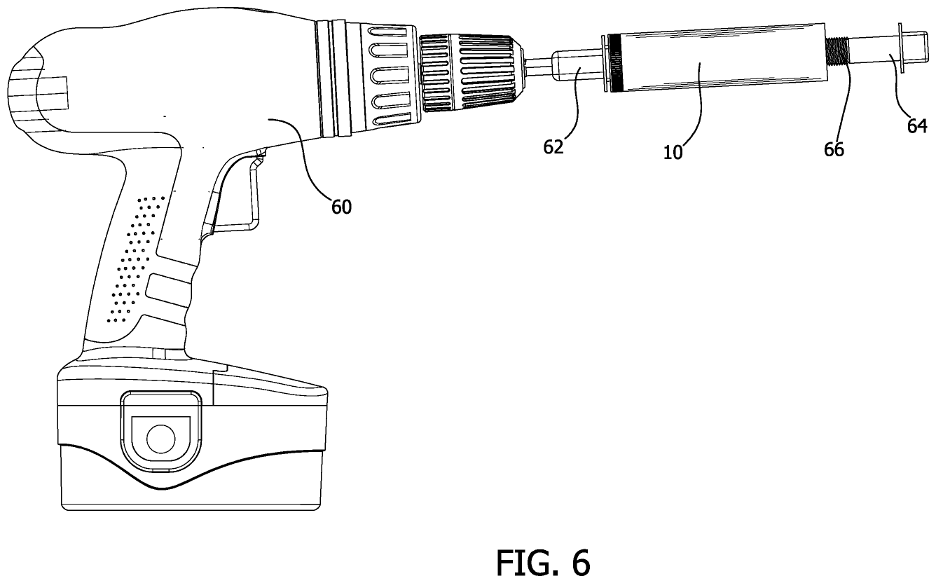

With reference now to the drawings, and in particular to FIGS. 1 through 6 thereof, a new extended bolt rethreading tool embodying the principles and concepts of an embodiment of the disclosure and generally designated by the reference numeral 10 will be described.

As best illustrated in FIGS. 1 through 6, the extended bolt rethreading tool 10 generally includes a tool body 12 having a connecting portion 14 and a rethreading portion 16. The tool body 12 is elongated and cylindrical. The tool body 12 includes a first end face 18 and a second end face 20 positioned at opposite ends of the tool body 12. The connecting portion 14 includes a connecting receptacle 22 having a connecting orifice 24 positioned in the first end face 18. The connecting receptacle 22 is designed to receive a drive head 62 of a power drill 60, impact driver, ratchet, or similar tool to detachably connect the tool body 12 to a drive head 62 of a power drill 60, impact driver, ratchet, or similar tool to permit rotation of the tool body 12 in a rethreading procedure. The rethreading portion 16 includes a rethreading receptacle 26 having a rethreading orifice 28 positioned in the second end face 20. The rethreading receptacle 26 includes female threading 30 positioned on an interior surface of the rethreading receptacle 26. The rethreading receptacle 26 is designed to receive and engage a threaded bolt 64 or similar structure therein to permit a user to rethread a threaded bolt 64 or similar structure using a power drill 60, impact driver, ratchet, or similar tool.

In accordance with at least one possible embodiment, the rethreading receptacle 26 is sufficiently long to receive therein all or essentially all or substantially all of a threaded portion 66 of a threaded bolt 64 or similar structure. This length of the rethreading receptacle 26 is important because rethreading nuts are open-ended and thus can be advanced along the entire length of the threaded portion 66, whereas the rethreading receptacle 26 is closed because of the connecting end. The rethreading receptacle 26 therefore must be sufficiently long to be able to rethread all or at least a substantial portion of the threading. In addition, when the threaded bolt 64 is in a generally inaccessible or tight area, this added length could allow the user to reach the threaded bolt 64 with the rethreading receptacle 26 in contrast to a very short rethreading nut.

In accordance with at least one possible embodiment, the rethreading portion 16 includes channels 32 positioned adjacent and partially overlapping the rethreading receptacle 26 to divide the female threading 30 into longitudinal sections and designed to permit expansion of the rethreading receptacle 26 and to receive metal shavings produced in a rethreading procedure.

In accordance with at least one possible embodiment, the connecting receptacle 22 is essentially square or hexagonal.

In accordance with at least one possible embodiment, the rethreading receptacle 26 is at least about 0.75 inches (19.05 mm) to about 2.5 inches (63.5 mm) in length.

In accordance with at least one possible embodiment, the extended bolt rethreading tool 10 is combined with a plurality of other extended bolt rethreading tools 10 to form a rethreading kit. The rethreading receptacles 26 of each of the extended bolt rethreading tools 10 of the kit have different lengths and/or diameters to permit a user to rethread threaded bolts 64 or similar structures of different lengths and/or diameters. The rethreading receptacles 26 can be designed to match standard or common dimensions of threaded bolts 64 according to U.S. (inches) or international standards (millimeters) so the user can rethread different threaded bolts 64.

In use, the user connects the drive head 62 of a power drill 60, impact driver, ratchet, or similar tool to the connecting receptacle 22. The user then inserts a threaded portion 66 of a threaded bolt 64 or similar structure into the rethreading receptacle 26. The user then operates the power drill 60, impact driver, ratchet, or similar tool and rotates the tool body 12 and thereby rethreads the threaded portion 66. In the situation where the user has a rethreading kit of different-sized extended bolt rethreading tools 10, the user simply attaches a different extended bolt rethreading tool 10 and repeats the steps to rethread a threaded bolt 64 of a different length and/or diameter.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An extended bolt rethreading tool comprising:
a tool body being elongated and cylindrical;
said tool body comprising a connecting portion and a rethreading portion;
said tool body comprising a first end face and a second end face disposed at opposite ends of said tool body;
said connecting portion comprising a connecting receptacle having a connecting orifice disposed in said first end face;
said connecting receptacle being configured to receive a drive head of a power drill, impact driver, ratchet, or similar tool to detachably connect said tool body to a drive head of a power drill, impact driver, ratchet, or similar tool to permit rotation of said tool body in a rethreading procedure;
said rethreading portion comprising a rethreading receptacle having a rethreading orifice disposed in said second end face;
said rethreading receptacle comprising female threading disposed on an interior surface of said rethreading receptacle; and
said rethreading receptacle being configured to receive and engage a threaded bolt or similar structure therein to permit a user to rethread a threaded bolt or similar structure using a power drill, impact driver, ratchet, or similar tool.

2. The extended bolt rethreading tool of claim 1, wherein said rethreading receptacle is sufficiently long to receive therein all or essentially all or substantially all of a threaded portion of a threaded bolt or similar structure.

3. The extended bolt rethreading tool of claim 2, wherein said rethreading portion comprises channels disposed adjacent and partially overlapping said rethreading receptacle to divide said female threading into longitudinal sections and configured to permit expansion of said rethreading receptacle and to receive metal shavings produced in a rethreading procedure.

4. The extended bolt rethreading tool of claim 3, wherein said connecting receptacle is essentially square or hexagonal.

5. The extended bolt rethreading tool of claim 4, wherein said rethreading receptacle is at least about 0.75 inches (19.05 mm) to about 2.5 inches (63.5 mm) in length.

6. The extended bolt rethreading tool of claim 1, wherein said rethreading portion comprises channels disposed adjacent and partially overlapping said rethreading receptacle to divide said female threading into longitudinal sections and configured to permit expansion of said rethreading receptacle and to receive metal shavings produced in a rethreading procedure.

7. The extended bolt rethreading tool of claim 1, wherein said connecting receptacle is essentially square or hexagonal.

8. The extended bolt rethreading tool of claim 1, wherein said rethreading receptacle is at least about 0.75 inches (19.05 mm) to about 2.5 inches (63.5 mm) in length.

9. The extended bolt rethreading tool of claim 5, in combination with a plurality of other extended bolt rethreading tools to form a rethreading kit, wherein said rethreading receptacles of each of said extended bolt rethreading tools have different lengths and/or diameters to permit a user to rethread threaded bolts or similar structures of different lengths and/or diameters with said rethreading kit.

10. The extended bolt rethreading tool of claim 1, in combination with a plurality of other extended bolt rethreading tools to form a rethreading kit, wherein said rethreading receptacles of each of said extended bolt rethreading tools have different lengths and/or diameters to permit a user to rethread threaded bolts or similar structures of different lengths and/or diameters with said rethreading kit.

11. A method of rethreading a threaded bolt or similar structure using said extended bolt rethreading tool of claim 1, comprising:
connecting a drive head of a power drill, impact driver, ratchet, or similar tool to said connecting receptacle;
inserting a threaded portion of a threaded bolt or similar structure into said rethreading receptacle; and
operating said power drill, impact driver, ratchet, or similar tool and rotating said tool body and thereby rethreading said threaded portion.

12. The method of claim 11, further comprising repeating said steps of connecting, inserting, and operating using another bolt rethreading tool having a rethreading receptacle of a different length and/or diameter and thereby rethreading a threaded portion of a threaded bolt or similar structure of a different length and/or diameter.
